(19) United States
(12) Patent Application Publication
(10) Pub. No.: US 2019/0195007 A1
(43) Pub. Date: Jun. 27, 2019

(54) Gear Driven Louver Shutter System

(71) Applicant: Tony Yen, San Diego, CA (US)

(72) Inventor: Tony Yen, San Diego, CA (US)

(21) Appl. No.: 16/289,582

(22) Filed: Feb. 28, 2019

Related U.S. Application Data
(63) Continuation-in-part of application No. 15/726,328, filed on Oct. 5, 2017, now abandoned.

(51) Int. Cl. E06B 7/096; E05F 11/14

(52) U.S. Cl. CPC E06B 7/096; E05F 11/14

(57) ABSTRACT

The present invention is a gear driven louver shutter system, wherein each louver of the shutter system is attached to the end of a pinion on at least one end. A plurality of teeth of each pinion is engaged with a gear track disposed within each frame member. When one louver is adjusted, all the louvers in the shutter system will move accordingly, due to the movement of the gear strip rotating the pinions in that frame member at the same rate.

### CROSS-REFERENCE TO RELATED APPLICATION(S)

The present application is a Continuation in Part of U.S. Ser. No. 15/726,328, filed on Oct. 5, 2017 and entitled “Gear Driven Louver Shutter System”, the entire disclosure of which is incorporated by reference herein.

### BACKGROUND OF THE INVENTION

### 1. Field of Invention

The present invention relates to the field of shutter systems, and more specifically to shutter systems which utilize a plurality of adjustable louvers.

### 2. Description of Related Art

Louvers were first seen in the Middle Ages to allow ventilation, while still offering protection against natural elements such as rain, snow, or heavy wind. These louver systems were primarily comprised of fixed louvers and were commonly placed onto roof holes in kitchens to allow smoke and steam to escape.

Modern shutter systems, which utilize a plurality louvers, first started appearing in the early 1900s. The louvers of the shutters were adjustable and could be open or closed when a user pulled a handle or turned a hand-crank. All of the louvers in the shutter system would be connected with a tilt bar, such that all of the louvers in the system would remain parallel as they were adjusted. The louvers were commonly made from wood, glass, vinyl, PVC, or aluminum.

Many louver assemblies seen today do not come equipped with a handle or hand crank, instead the user simply adjusts the tilt bar or one of the louvers to adjust the angle of all of the louvers in the assembly. While a tilt bar can successfully keep all louvers of a shutter assembly in a parallel with one another, it can be an unsightly feature which some users prefer not to look at. Hidden tilt bars may be used which nest inside the stile of the shutters, however their implementation prevents the louvers from fully closing in both direction.

Based on the foregoing, there is a need in the art for a shutter assembly wherein the tilt of the louvers may be controlled by a hidden apparatus. What may be further desired is a hidden apparatus to control the tilt of the louvers and allows for the louvers to be closed in both directions without obstruction of the view.

### SUMMARY OF THE INVENTION

In an embodiment, a louver shutter system is provided as two frame members separated by a plurality of louvers. Two gear tracks are disposed within at least one of the frame members. Each gear track is formed a gear strip having a plurality of apertures with a plurality of gear racks inserted into the apertures.

In an embodiment, a plurality of pinions is removably engaged with the gear racks of the gear tracks via a plurality of teeth provided on a portion of the pinion. The pinons are further provided with one or more connector pins. Each of the pinions engages with one end of a louver via the connector pins.

When one louver is adjusted, all the louvers in the shutter system will move accordingly, due to the movement of the gear strip rotating the pinions in that frame member at the same rate.

The foregoing, and other features and advantages of the invention, will be apparent from the following, more particular description of the embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a front elevational view of the gear driven louver shutter system, according to an embodiment of the present invention;

FIG. 2 is a perspective view of the frame component of the gear driven louver shutter system, according to an embodiment of the present invention;

FIG. 3 is a perspective view of the pinion component of the gear driven louver shutter system, according to an embodiment of the present invention;

FIG. 4 is a cross-section view of the gear driven louver shutter system, according to an embodiment of the present invention;

FIG. 5 is a cross-section view of the gear driven louver shutter system, according to an embodiment of the present invention;

FIG. 6 is an exploded view of the gear driven louver shutter system, according to an embodiment of the present invention;

FIG. 7 is an exploded view of the gear driven louver shutter system, according to an embodiment of the present invention;

FIG. 8 is a perspective view of the connector pin of the gear driven louver shutter system, according to an embodiment of the present invention;

FIG. 9 is a front elevational view of the gear driven louver shutter system, according to an embodiment of the present invention;

FIG. 10 is a cut away of the frame member gear driven louver shutter system, according to an embodiment of the present invention;

FIG. 11 is a cross-section view of the gear driven louver shutter system, according to an embodiment of the present invention;

FIG. 12 is a cross-section view of the gear driven louver shutter system, according to an embodiment of the present invention;

FIG. 13 is a perspective view of the frame component of the gear driven louver shutter system, according to an embodiment of the present invention;

FIG. 14 is a perspective view of the pinion component of the gear driven louver shutter system, according to an embodiment of the present invention; and

FIG. 15 is a perspective view of the gear strip component of the gear driven louver shutter system, according to an embodiment of the present invention.

### DETAILED DESCRIPTION OF EMBODIMENTS

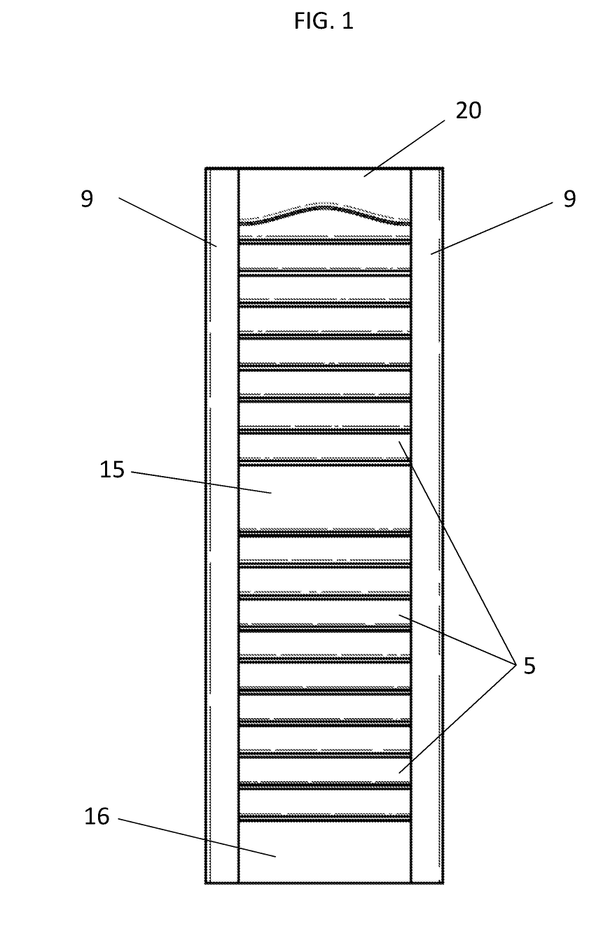

Embodiments of the present invention and their advantages may be understood by referring to FIGS. 1-15, wherein like reference numerals refer to like elements.

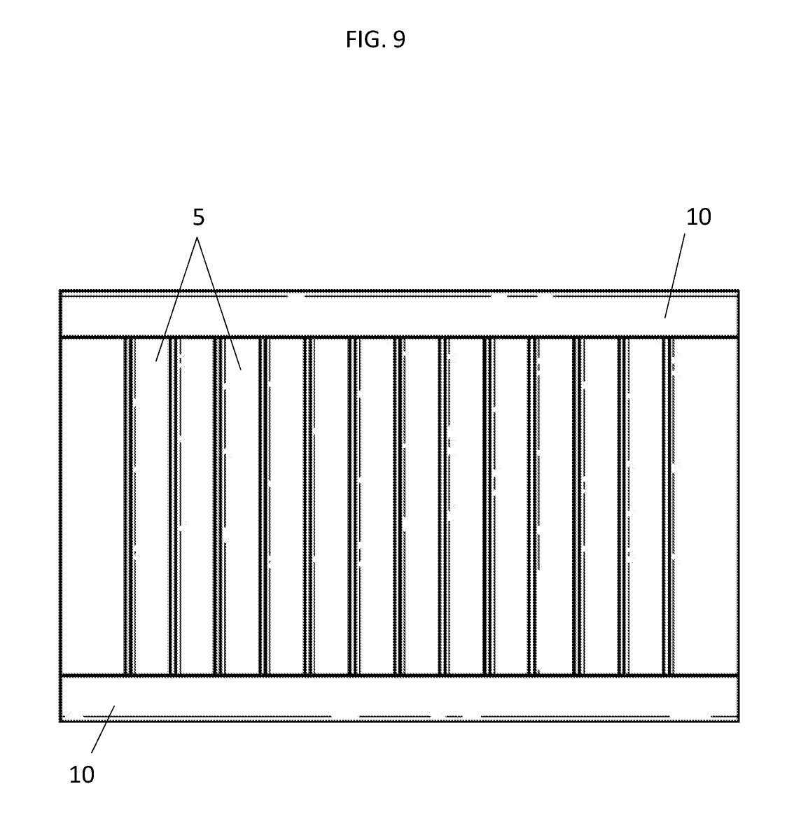

In reference to FIG. 1, a complete shutter assembly is shown, wherein a plurality of louvers 5 have been mounted to the frame members (not shown) and the frame members have been inserted into the stiles 9. In the embodiment, the louvers 5 are positioned horizontally, in another embodiment, the louvers 5 may be positioned vertically (as shown in FIG. 9). In the embodiment, the shutter assembly if further comprised of a midrail 15, a bottom rail 16, and a top rail 20. In another embodiment, the shutter assembly may contain more midrails, bottom rails, top rails, or none at all.

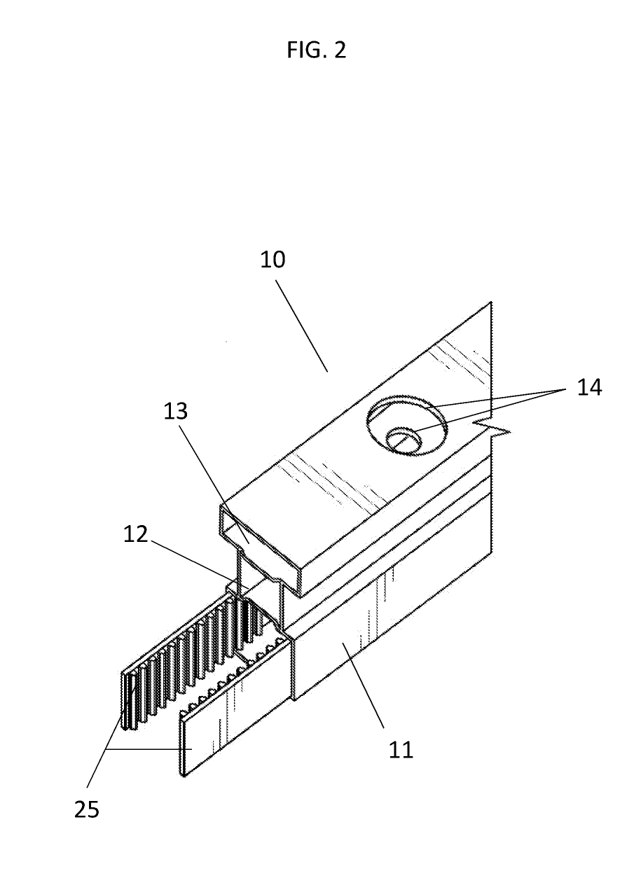

In reference to FIG. 2, according to an embodiment of the present invention, a frame member 10 is shown with two gear strips 25 inserted into the gear track 11 of the frame member 10. The frame member 10 is further comprised of a shaft cavity 12, a neck cavity 13, and drilled holes 14 such that the frame member is able to receive a pinion (not shown).

In an embodiment, the frame member 10 is comprised of aluminum which is created via extrusion. In another embodiment, the frame member 10 may be any metal, wood, plastic, or other material deemed suitable.

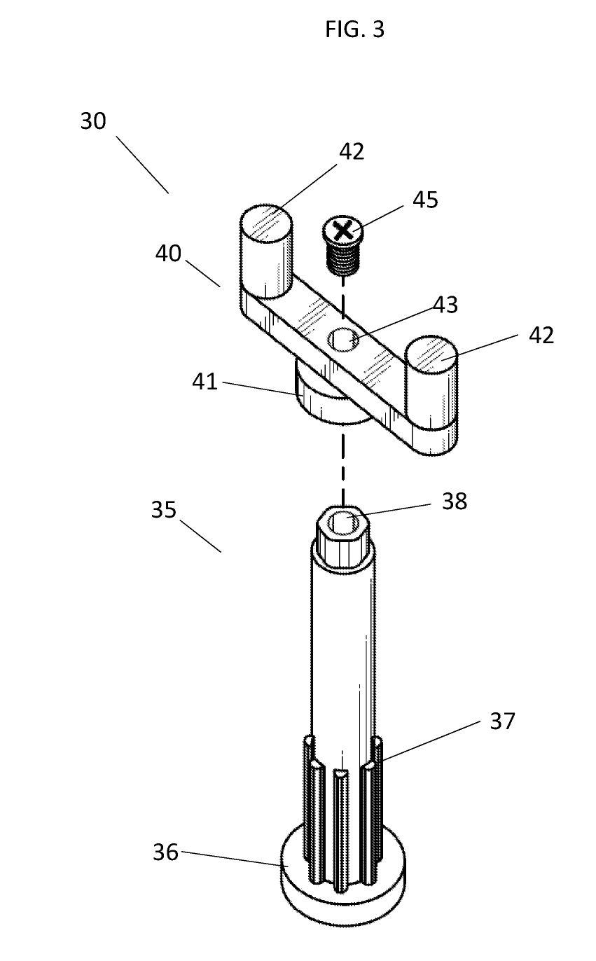

In reference to FIG. 3, according to an embodiment of the present invention, a pinion 30 is comprised of a gear drive shaft 35 and connector pin 40. In an embodiment, the shaft 35 is further comprised of a guide washer 36, to retain the pinion 30 inside the frame member (not shown). The shaft 35 further comprises of a plurality of gears 37 to engage with a gear strip (not shown).

In an embodiment, the connector pin 40 is further comprised of a line-up joint 41 to retain the position of the pinion 30 when inserted into a frame member (not shown). The connector pin is further comprised of two louver pins 42 to adapted to engage with a louver or louver clip (not shown). In another embodiment, the connector pin may have one louver pin with teeth or more than two louver pins.

In the embodiment shown in FIG. 3, the gear drive shaft 35 and connector pin 40 are fastened together to form the pinion 30, via a connector screw 45. The connector screw 45 is received by a counter-sunk aperture 43, provided in the connector pin 40, and a threaded aperture 38 provided on the gear drive shaft 40. In the embodiment, a Philips type screw is used, however the screw used may be any type. In another embodiment, attachment of the shaft and pin may be achieved using a nut and bolt, snap on, or other connection deemed appropriate. In an embodiment, the end of the gear drive shaft 35 is a hexagonal shape provided to engage with the line-up joint 41 to prevent slipping between the pin and shaft. In another embodiment, the end of the gear drive shaft may be provided with teeth, be square, or another shape to prevent slipping between the pin and the shaft.

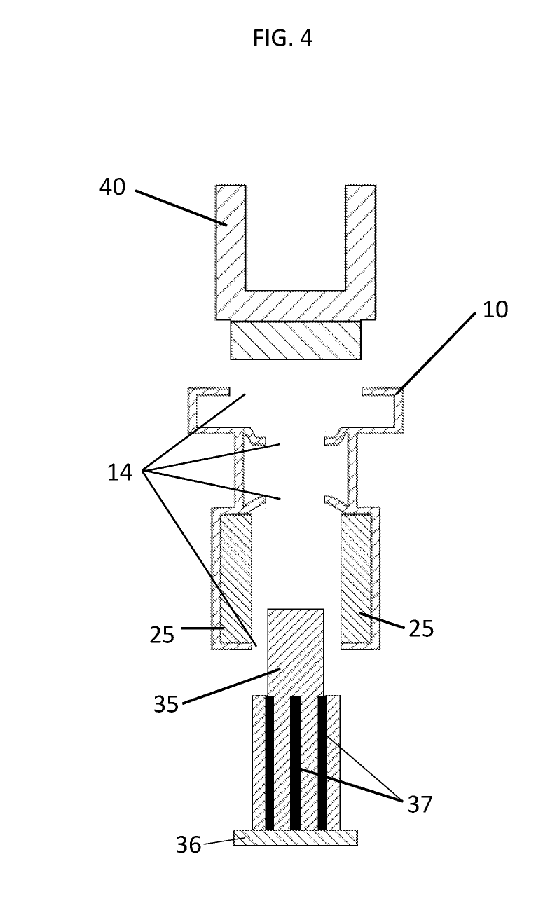

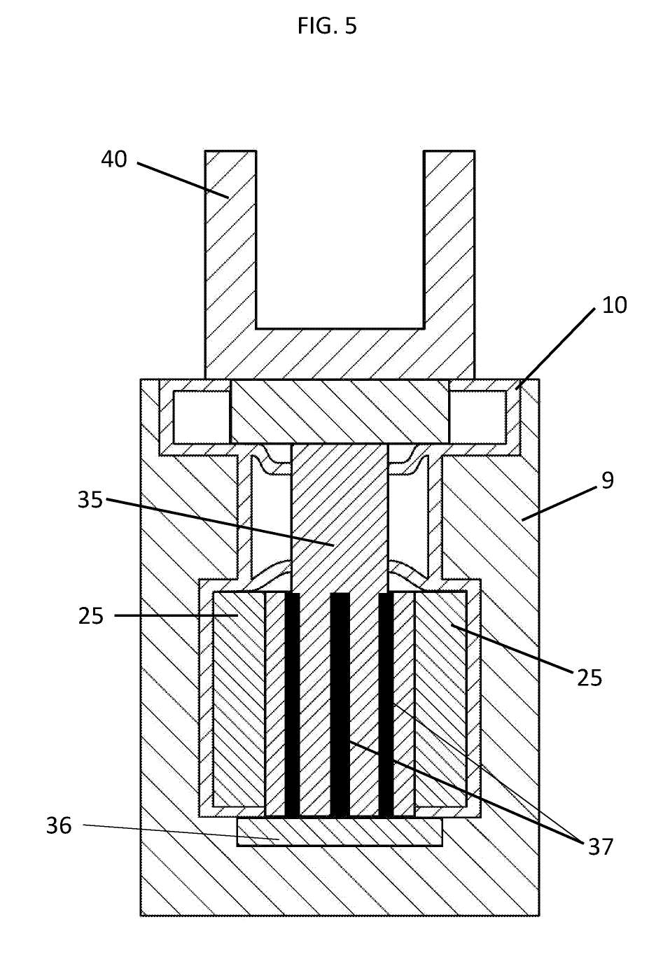

In reference to FIG. 4-5, a cross-sectional view of a pinion to be inserted into a frame member 10 is shown. In the embodiment shown, the frame member 10 has been drilled with four holes 14 to accommodate the pinion. The same four holes will be drilled at any location along the length of the frame member 10 in which a pinion is to be placed. In the embodiment, the gear drive shaft 35 and connector pin 40 are inserted separately into the holes 14 on opposing sides of the frame member 10, then assembled or connected via the preferred method of attachment.

When properly assembled, the gears 37 of the pinion are engaged with the gear strips 25, such that rotation of a pinion causes the gear strips to slide within the gear track. The rotation of one pinion, will then cause all other pinions assembled in the frame member to rotate in the same manner. In an embodiment, the assembled frame member is then inserted into a stile 9. The stile is provided to retain the frame members and hide the conceal the components of the assembly.

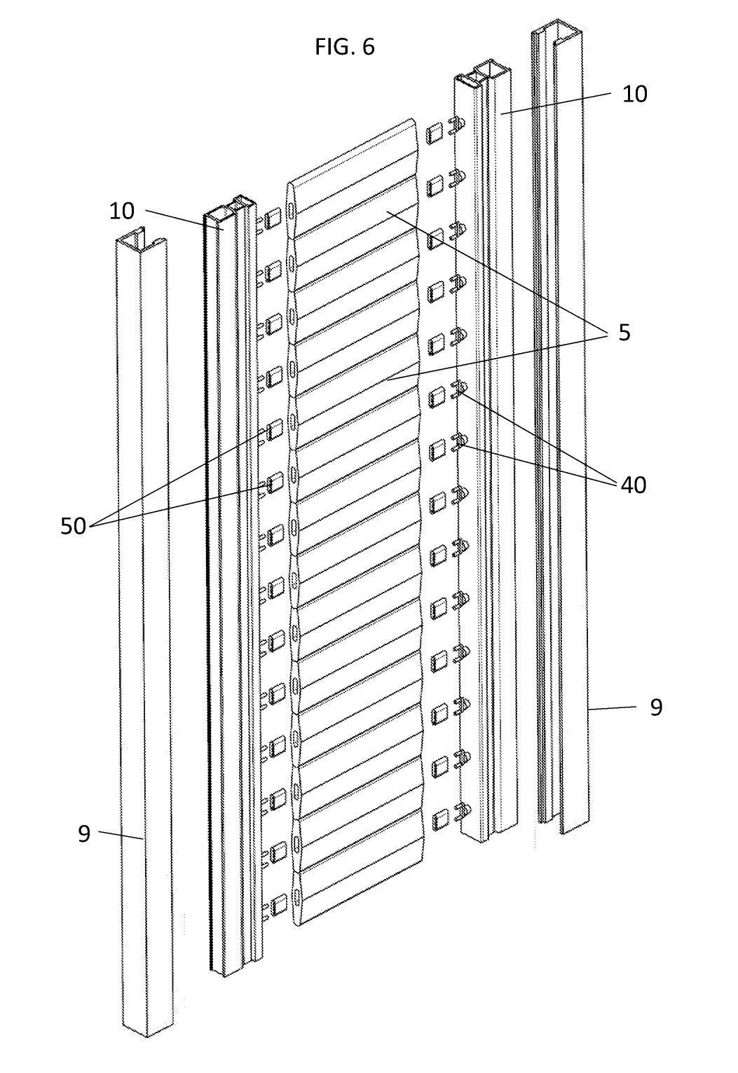

In reference to FIG. 6, according to an embodiment of the present invention, a shutter assembly is shown in an exploded state, having pinions and gear strips (not shown) assembled into the frame members 10. In the embodiment shown, louver clips 50 are provided to be inserted into the louvers 5 and attached to the connector pins 40 of the pinion. In the embodiments, the louver clips 50 are snapped onto the connector pins 40 and snapped into the louvers 5. In other embodiments, the louver clips 50 may be adhered into the louvers 5 or fit into the louvers with a transitional tolerance. In another embodiment, the louvers may contain holes which allow for direct insertion of the connector pins 40 into the louvers 5 without a louver clip.

In an embodiment, each the frame members 10 are inserted into a stile 9 after they are assembled. The stiles 9, are provided to conceal the components of the frame member which may be considered unsightly. When utilized, the stiles 9 give the shutter system a clean appearance without a tilt bar.

In the embodiment, the louvers are assembled in position to be parallel with one another. The assembly is provided to allow a user to tilt one louver, twisting its pinions and moving the gear strip to tilt all the louvers in the assembly, such that they remain parallel with one another. This arrangement relinquishes the need for a tilt bar, as seen in most shutter assemblies.

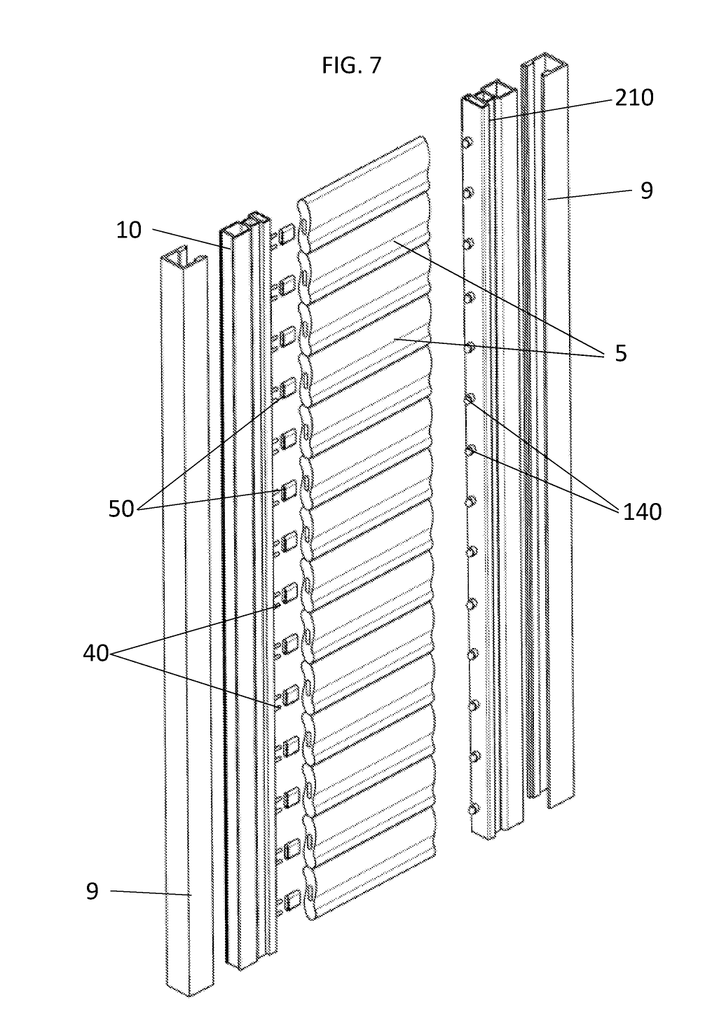

In reference to FIG. 7, according to an embodiment of the present invention, a shutter assembly similar to the shutter assembly of FIG. 6 is shown, wherein louvers 5 are shown having a curved profile as a variation. The curved profile allows for light for complete blocking of light when the louvers 5 are arranged with a slight overlap. It could be appreciated, that the profile of the louvers may be further varied to achieve a desired aesthetic. In the embodiment, one side of the shutter assembly is provided with a support frame 210 having louver supports 140. In the embodiment, the louver supports are comprised of a single pin which is inserted into one end of each louver. In another embodiment, the louver supports are each inserted into a louver clip and the louver clips are inserted into each louver. In an embodiment, the louver supports are an integrated component of the support frame. In another embodiment, the louver supports are removably inserted into through holes provided in the support frame. In an embodiment, the louver supports have a smooth circumference such that the louvers or louver clips may rotate freely about the support. In the embodiment, the support frame is not provided with a gear system.

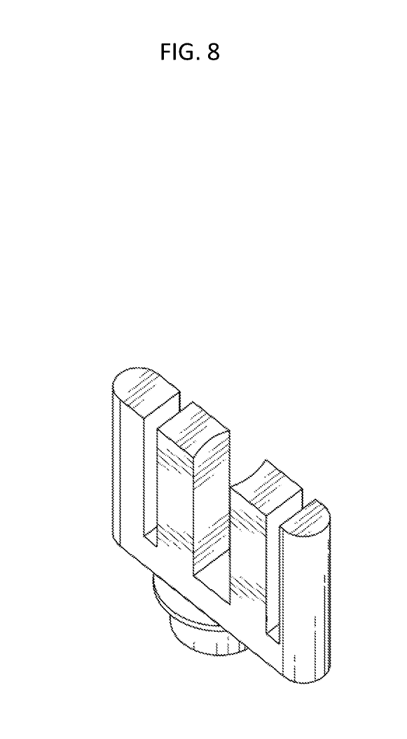

In reference to FIG. 8, according to an embodiment of the present invention, a variation of the connector pin is shown have four pins to engage with a louver clip or louver. In the variation shown, the connector pin does not have an aperture for a fastening component such as a screw, however one can consider additional variations of the connector pin in which an aperture for a fastener is provided. In another embodiment, varying pin numbers and shapes may be used.

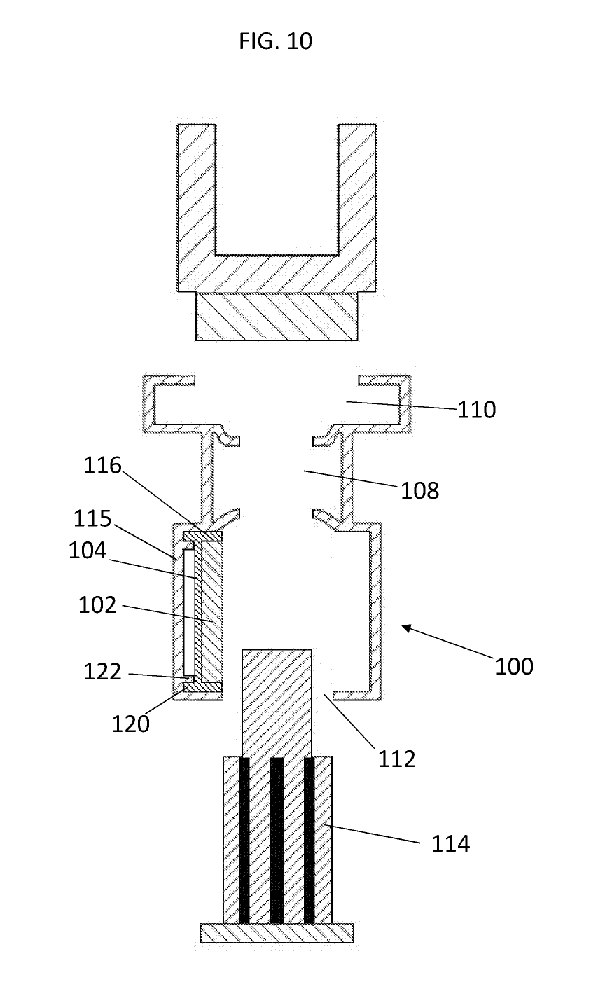

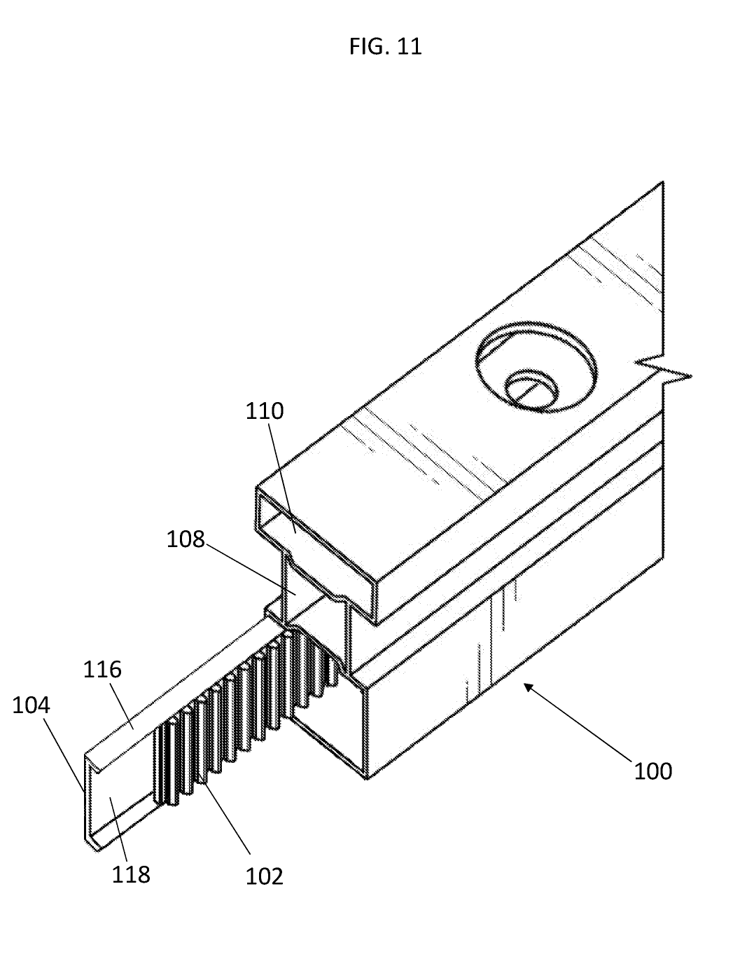

In reference to FIG. 10-11, according to an embodiment of the present invention, a frame member 100 is shown with a gear strip 102 inserted into the frame member 100. A low-friction glide strip 104 is interposed between the gear strip 102 and a wall 115 of the frame member. The frame member 100 is further comprised of a shaft cavity 108, an optional neck cavity 110, and pinion holes 112 such that the frame member is able to receive a pinion 114. The pinion 114 may be inserted through a pinion hole 112 to interface with the gear strip 102 within the frame member 100.

In an embodiment, the glide strip 104 has two protrusions 116 forming a channel 118, within which the gear strip 102 may glide, without contacting the walls of the frame member 100. The glide strip may be made of a low-friction plastic material known in the art, that reduces the friction between a sliding gear strip 102 and channel 118.

The glide strip may be held within the gear track with a friction fit, and/or may have one or more protrusions 120 on the reverse to interface with a clamp or groove 122 on the inside wall of the frame member.

In an embodiment, the frame member 10 and frame member 100 are comprised of aluminum, which is created via extrusion. In another embodiment, the frame member 10 or 100 may be any metal, wood, plastic, or other material deemed suitable.

In an embodiment, the louvers are comprised of wood. In other embodiments, the louvers may be comprised of vinyl, polyvinyl chloride (PVC), composite, acrylic, aluminum, or any material deemed suitable. In an embodiment, the pinions and gear strips are comprised of plastic. In another embodiment, the pinions and gear strips may be comprised of vinyl, polyvinyl chloride (PVC), composite, acrylic, aluminum, or any material deemed suitable.

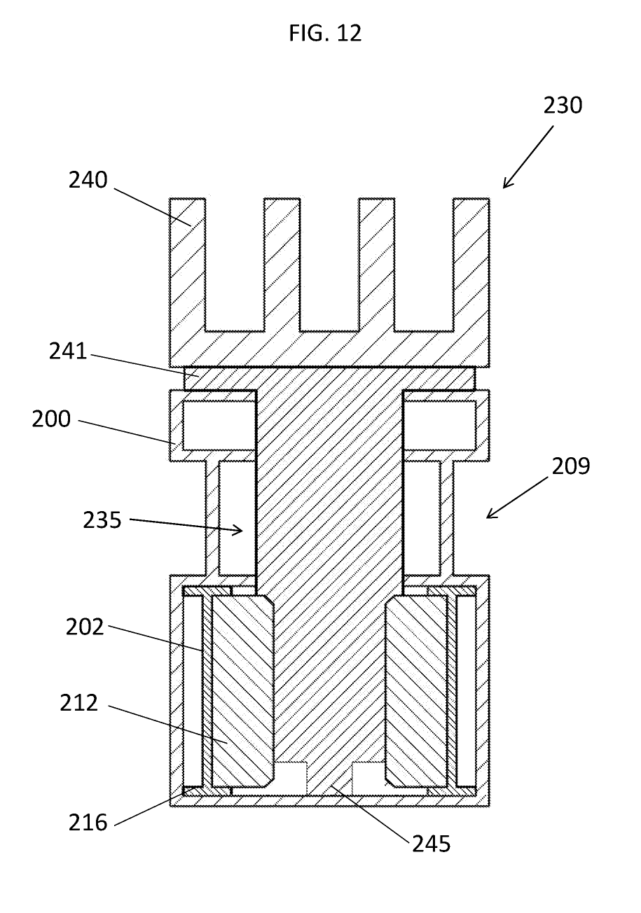

With reference to FIGS. 12-15, another embodiment of the gear driven louver shutter system is depicted. In an embodiment, the system is provided with two gear tracks 211 to be inserted into the lower portion of the frame member 200. In an embodiment, each gear track is comprised of a gear strip 202 having a plurality of apertures to receive gear racks 212. In the embodiment, the connector pins 240, collar 241, and drive shaft 235, which are all integrated as a single, integrated pinion component 230. A plurality of pinions 230 are provided for the system and each pinion is inserted into a through hole 214. A plurality of through holes 214 are provided along the length of the frame member 200. In the embodiment, each through hole is provided with the same diameter throughout the frame member.

With reference to FIG. 12, a cross section view of the frame member 200 is shown according to an embodiment. In the embodiment shown, pinion 230 has been inserted into one of the through holes on one side of the frame member. The pinion is provided with a collar 241 below the connector pins 240. The collar is provided with a larger diameter than the through hole and the drive shaft 235, such that the collar rests against one side of the frame member. In the embodiment, two gear tracks have been inserted into the frame member. However, an embodiment using only one gear track would still produce a functional system. Each gear track has a gear strip 202 with a plurality of apertures to receive removable gear racks 212. The gear racks engage the teeth of each pinion. In an embodiment, the gear strips 202 are provided with two protrusions 216 and have a substantially ‘I’ shaped cross-section. In the embodiment, the protrusions are provided to reduce the surface area of the gear strip against the frame member, such that friction is reduced. In an embodiment, the end of the gear shaft, opposite of the connector pin, is provided with a reduced diameter portion 245 to decrease friction against the frame member. In an embodiment, the frame member 200 is provided with indentations 209, such that a decorative stile may engage with and cover the frame member (similar to the depiction in FIG. 5 of stile 9 engaging with the frame member).

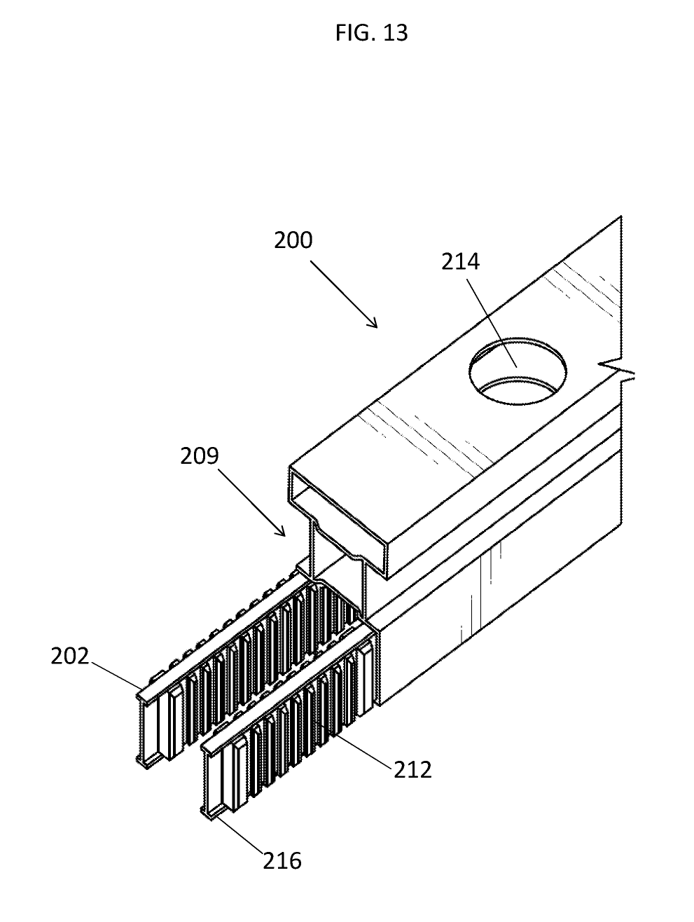

In an embodiment, with reference to FIG. 13, a portion of a frame member 200 is depicted. The frame member is provided with a plurality of through holes 214 to receive a pinion. Each through hole consists of the same diameter throughout the frame member. In the embodiment, two gear tracks have been inserted into the frame member. Each gear track has a gear strip 202 with a plurality of apertures to receive removable gear racks 212. The gear racks engage the teeth of each pinion. In an embodiment, the gear strips 202 are provided with two protrusions 216 at each end and have a substantially ‘I’ shaped cross-section. In an embodiment, the frame member 200 is provided with indentations 209, such that a decorative stile may engage with and cover the frame member (similar to the depiction of stile 9 engaging with the frame member in FIG. 5).

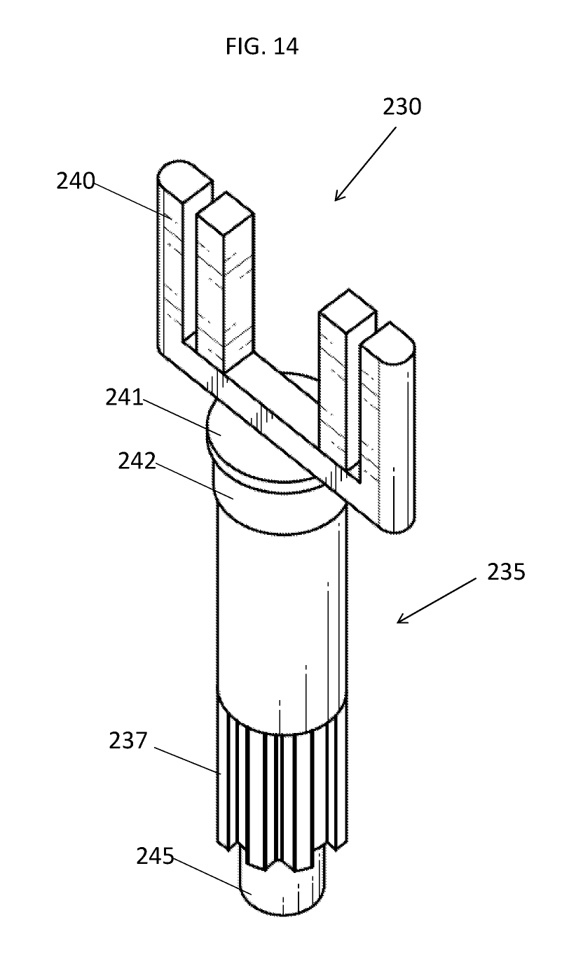

With reference to FIG. 14, an embodiment of the pinion component 230 is shown. In the embodiment, the connector pins 240, collar 241, and drive shaft 235, which are all integrated as a single, integrated pinion component. In the embodiment, the drive shaft 235 includes a plurality of teeth 237 to form a gear. In the embodiment, the plurality of teeth are formed by a plurality of reductions in diameter, and not by protrusions. In an embodiment, the pinion is further provided with a tolerance collar 242. The tolerance collar provides a tight fit with the outer aperture of the frame member to prevent the attached louvers from wiggling. In an embodiment, the end of the gear shaft, opposite of the connector pin, is provided with a reduced diameter portion 245 to decrease friction against the frame member. In an embodiment, the pinion is comprised of plastic or another polymer which is both lightweight and cost effective. The pinion may also be provided with an aperture or through hole in the center to further reduce weight.

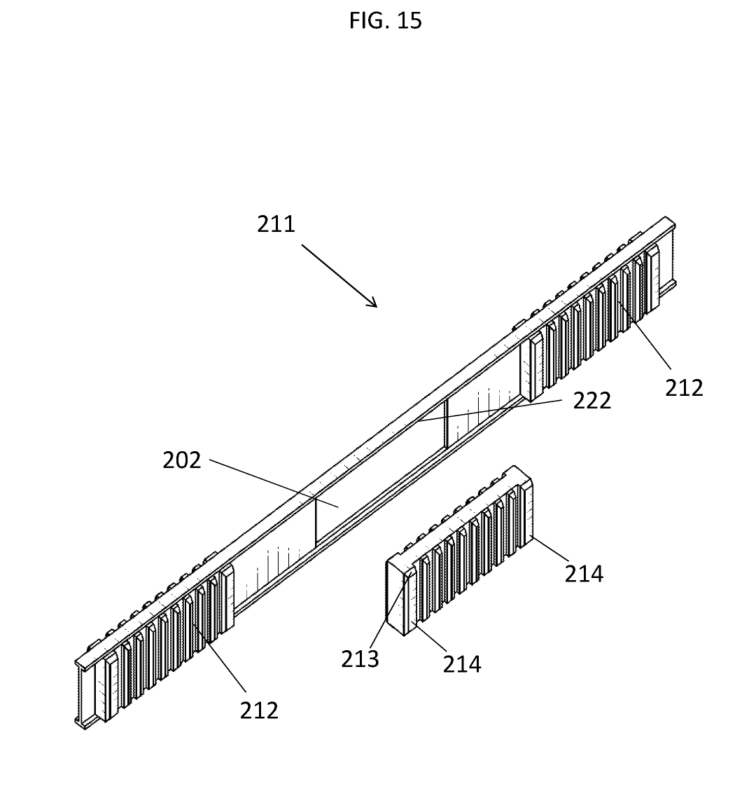

With reference to FIG. 15, an embodiment the gear track 211 is formed by a gear strip 202 with a plurality of apertures 222 to receive removable gear racks 212. The gear racks engage the teeth of each pinion. In an embodiment, the gear racks are provided with a stop 214 at the ends to prevent the pinions from disengaging with the gear racks. In an embodiment, the gear strips 202 are provided with two protrusions 216 and have a substantially ‘I’ shaped cross-section. In the embodiment, the protrusions are provided to reduce the surface area of the gear strip against the frame member, such that friction is reduced. In an embodiment, one side of the gear racks 212 are provided with a bevel 213 to allow easier insertion into the apertures 222. The embodiment having a gear strip with apertures to receive the gear racks allows for the gear strips and gear racks to be comprised of different materials. In an embodiment, the gear racks are comprised of a plastic or polymer to be both light weight and cost effective. In an embodiment, the gear strips are comprised of aluminum which is lightweight but more resistant to bending within the frame member, as the aluminum has a higher tensile and compressive strength than plastic. In an embodiment, the aluminum used for the gear strip is provided with a polymeric coating to reduce the frictional when the gear strip is in contact with a frame member.

In an embodiment of the present invention, an electric motor with a pinon adapted to engage with the gear strips can be implemented to create an electrically driven shutter system. In the embodiment, a remote system may be added to control the motor via remote control, allowing the shutters to be open and closed using a remote. Furthermore, this system could be adapted to an internet of things to allow a user to open and close shutter systems in their home using their mobile device.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A louver shutter system comprising:
two frame members separated by a plurality of louvers, at least one frame member having two gear tracks disposed within, each of the two gear tracks comprised of a gear strip having a plurality of apertures configured and a plurality of gear racks removably inserted into said apertures; and
a plurality of pinions removably engaged with the at least one frame member having two gear tracks disposed within, each pinion having a plurality of teeth to engaged with the gear racks and one or more connector pins to engage with a louver of the plurality of louvers,
wherein the system is configured such that a rotation of a single louver causes a rotation of the plurality of louvers.

2. The louver shutter system of claim 1, further comprising a plurality of louver clips to engage with the one or more connector pins and insert into the plurality of louvers.

3. The louver shutter system of claim 1, wherein each louver of the plurality of louvers is provided with an S-shaped cross section configured to seal with an adjacent louver and block light.

4. The louver shutter system of claim 1, wherein all louvers of the plurality of louvers are provided in parallel relative to one another.

5. The louver shutter system of claim 1, wherein the one or more connector pins are further provided with a plurality of teeth to prevent slipping.

6. The louver shutter system of claim 1, wherein the plurality louvers are adapted to snap onto the one or more connector pins without the use of a tool.

7. The louver shutter system of claim 1, wherein each gear strip is comprised of aluminum and wherein each gear rack is comprised of plastic.

8. The louver shutter system of claim 7, wherein each gear strip further comprises a polymeric coating.

9. The louver shutter system of claim 1, wherein the plurality of pinions are inserted into apertures provided in the two frame members, and wherein the apertures have a consistent diameter.

10. The louver shutter system of claim 1, wherein each gear strip is provided with two protruding ends to form a substantially I-shaped cross-section.

11. The louver shutter system of claim 10, wherein each gear strip is comprised of aluminum and wherein each gear rack is comprised of plastic.

12. The louver shutter system of claim 11, wherein each gear strip further comprises a polymeric coating.

13. The louver shutter system of claim 1, wherein each gear rack is provided with a beveled edge, and wherein each gear rack further comprises a stop at each end.

14. The louver shutter system of claim 1, wherein one of the two frame members is a support member, and wherein the support member is comprised of a plurality of louver supports each having a smooth circumference.

15. The louver shutter system of claim 1, wherein each pinion is a single integrated component.

16. The louver shutter system of claim 15, wherein the plurality of teeth of each pinion are formed by a plurality of reductions in diameter.

17. The louver shutter system of claim 16, wherein each pinion is further provided with a collar.

18. The louver shutter system of claim 17, wherein each pinion is further provided with a tolerance collar.

19. The louver shutter system of claim 17, wherein each pinion is further provided with a reduced diameter portion at an end opposite to the one or more connector pins.

20. The louver shutter system of claim 1, wherein both of the two frame members have two gear tracks disposed within and a plurality of pinions removably engaged with the two gear tracks.
